(19) United States
(12) Patent Application Publication
(10) Pub. No.: US 2009/0172110 A1
(43) Pub. Date: Jul. 2, 2009

(54) SYSTEMS AND METHODS TO IDENTIFY INTERNAL AND EXTERNAL EMAIL

(76) Inventors: Peter Eberlein, Malsch (DE); Matthias Buhl, Heidelberg (DE)

Correspondence Address: SAP AG c/o BUCKLEY, MASCHOFF & TALWALKAR LLC, 50 LOCUST AVENUE, NEW CANAAN, CT, 06840, US

(21) Appl. No.: 11/967,498

(22) Filed: Dec. 31, 2007

(51) Int. Cl. G06F 15/16

(52) U.S. Cl. 709/206

(57) ABSTRACT

A system may include reception of an internet electronic mail message, parsing of a header of the internet electronic mail message to identify zero or more routing devices from which the internet electronic mail message was received, and a determination to accept or to reject the internet electronic mail message based on the identified zero or more routing devices.

### FIELD

Some embodiments relate to the identification of electronic mail messages. In particular, some embodiments concern identifying a received electronic mail message as internal or external.

### BACKGROUND

Internet electronic mail messages have become a ubiquitous form of interpersonal communication. Due to the efficiency and low cost with which electronic mail messages may be transmitted, the amount of abusive or fraudulent internet electronic mail messages has steadily risen. Many conventional systems have attempted to filter out such abusive or fraudulent internet electronic mail messages before reaching their intended recipient.

The Sender Policy Framework (SPF) allows a domain owner to specify its mail sending servers in an SPF record within the domain's DNS zone. If another mail server receives a message purporting to originate from the domain, the receiving server determines whether the message came from a mail sending server specified in the SPF record. If not, the message is discarded.

DomainKeys is an authentication system designed to verify the DNS domain of a mail sending server and the integrity of a message received therefrom. DomainKeys adds a “DomainKey-Signature” header to an electronic mail message that contains a digital signature of the contents of the mail message. The receiving server then uses the name of the domain from which the message originated, the string_domainkey, and a selector from the header to perform a DNS lookup. The returned data includes the domain's public key. The receiver can then decrypt the hash value in the header field and at the same time recalculate the hash value for the mail body that was received. If the two values match, the receiving server determines that the mail originated at the purported domain and has not been tampered with in transit.

S/MIME (Secure/Multipurpose Internet Mail Extensions) is a standard for public key encryption and signing of electronic mail messages encapsulated in MIME (e.g., RFC 2045-Multipurpose Internet Mail Extensions (MIME) Part One: Format of Internet Message Bodies). S/MIME requires a sender to obtain a public key/certificate for each a receiving party and to use the public key/certificate to encrypt electronic mail messages intended for the receiving party.

Each of the foregoing conventional systems requires prior agreement by the sender and the receiving party to perform specific actions. The systems also require specific infrastructure items. What is needed is an efficient system to facilitate identification of potentially undesirable electronic mail messages.

### BRIEF DESCRIPTION OF THE DRAWINGS

FIG. 1 is a diagram of a network topology according to some embodiments.

FIG. 2 is a flow diagram of a process according to some embodiments.

FIG. 3 is a diagram of an electronic mail attachment structure.

FIG. 4 is a representation of an electronic mail header according to some embodiments.

FIG. 5 is a representation of an electronic mail header according to some embodiments.

FIG. 6 is a representation of an electronic mail header according to some embodiments.

FIG. 7 is a representation of an electronic mail header according to some embodiments.

FIG. 8 is a detailed block diagram of a system according to some embodiments.

FIG. 9 is a block diagram of a network topology according to some embodiments.

FIG. 10 is a flow diagram of a process according to some embodiments.

FIG. 11 is a representation of an electronic mail header according to some embodiments.

### DETAILED DESCRIPTION

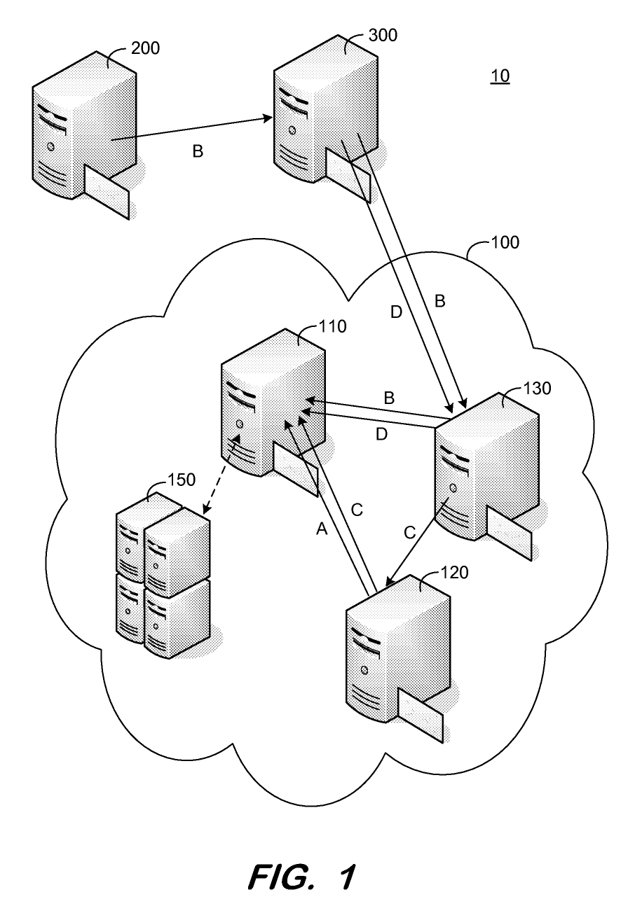

FIG. 1 is a block diagram of system 10 according to some embodiments. Two or more of elements of system 10 may be located remote from one another and may communicate with one another via any known manner of network(s) and/or a dedicated connection. Moreover, each element may comprise any number of hardware and/or software elements suitable to provide the functions described herein as well as any other functions. Other topologies may be used in conjunction with other embodiments.

Trusted network 100 of system 10 may comprise any number of devices that are selected, deployed and managed so as to maintain an appropriate level of security for their intended purposes. The intended purposes may include, but are not limited to, transmission and reception of electronic mail messages, supply chain management, and customer relationship management. Each function provided within network 100 may exhibit a different level of security. Trusted network 100 may be operated for in-house purposes by a single business entity and/or by an application service provider offering computing services to external entities.

Trusted network 100 includes electronic mail servers 110 through 130 and application servers 150. Each of servers 110 through 130 and 150 may include any number of disparate hardware and/or software elements, some of which may be located remotely from one another. The elements of trusted network 100 may communicate with one another (and with other non-illustrated elements) over any suitable communication media and protocols that are or become known.

Electronic mail servers 200 and 300 are disposed “outside” of trusted network 100. The term “outside” is not intended to convey any necessary physical relationship but rather to signify only that electronic mail servers 200 and 300 do not possess the characteristics which enable elements 110 through 130 and 150 to be considered trusted for a particular purpose. One or both of electronic mail servers 200 and 300 may belong to a trusted network other that trusted network 100.

Electronic mail servers 200 and 300 may be located proximate or remote from one another and/or from network 100. Electronic mail servers 200 and 300 are each capable of communication over a network (e.g., the Internet) with one or more other elements of FIG. 1.

Electronic mail servers 110 through 130, 200 and 300 may support Simple Mail Transport Protocol (SMTP) in order to ensure delivery of a received electronic mail message to an appropriate mailbox of an appropriate electronic mail server. In this regard, each of mail servers 110 through 130, 200 and 300 is associated with one or more internet domains, and is to receive internet electronic mail messages having recipient electronic mail addresses which include the domains with which it is associated.

During operation, one of mail servers 110 through 130, 200 and 300 may receive an internet electronic mail message having a recipient electronic mail address which does not include a domain of the mail server. The mail server therefore employs SMTP to forward the electronic mail message to another electronic mail server. As will be described in more detail below, a mail server may alter a header of a received electronic mail message prior to forwarding the message to another mail server. The process repeats until the electronic mail message is received by a mail server associated with the domain of its recipient electronic mail address.

Due to the foregoing, an electronic mail message may “hop” between several mail servers before reaching its intended destination. Transmission paths A through D illustrate examples of such hopping according to some embodiments.

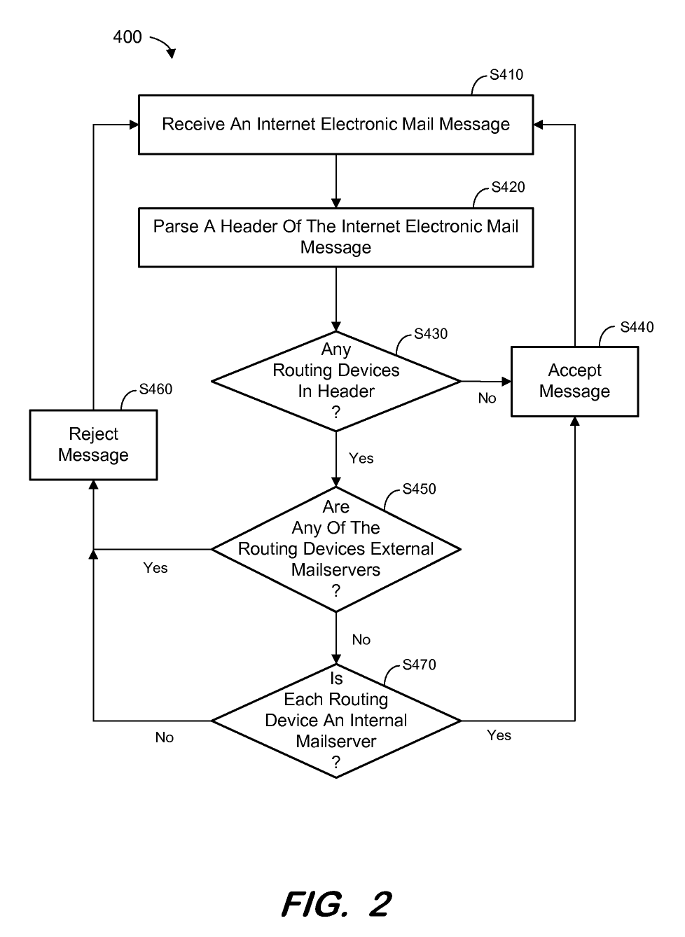

FIG. 2 is a flow diagram of process 400 according to some embodiments. Some embodiments of process 400 may provide efficient identification of internal and external electronic mail messages.

Process 400 and all other processes mentioned herein may be embodied in processor-executable program code read from one or more of a computer-readable medium, such as a floppy disk, a CD-ROM, a DVD-ROM, a Zip™ disk, a magnetic tape, and a signal encoding the process, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, an internet electronic mail message is received at S410. The internet electronic mail message may comply with Request For Comments (RFC) 2822-Internet Message Format, which specifies a syntax for text messages that are sent between computer users. The internet electronic mail message may also comply with one or more extensions thereto (e.g., RFC 2045-Multipurpose Internet Mail Extensions (MIME) Part One: Format of Internet Message Bodies, RFC 2046-Multipurpose Internet Mail Extensions (MIME) Part Two: Media Types, RFC 2049-Multipurpose Internet Mail Extensions (MIME) Part Five: Conformance Criteria and Examples).

As illustrated in FIG. 1 and described above, the electronic mail message may be received from a mail server. The following description will assume that the message is received at S410 from a mail server to which the message is addressed. More specifically, the message is received from a mail server associated with the domain of the message's recipient electronic mail address. Such a mail server may store the message in a mailbox associated with a local-part of the message's recipient electronic mail address.

The internet electronic mail message may be received at S410 by a client application capable of sending and receiving an internet electronic mail message. The client application may receive the electronic mail message using Post Office Protocol 3 (POP3), Internet Message Access Protocol (IMAP), Simple Mail Access Protocol (SMAP), or other standard protocols. These protocols specify mechanisms to query a mail server for electronic mail message stored in a particular mailbox and to provide authentication information.

According to some embodiments, application servers 150 receive the electronic mail message from mail server 110 at S410. Application servers 150 therefore execute a mail client to receive mail messages which specify a recipient domain and local-part associated, respectively, with server 110 and a mailbox thereof.

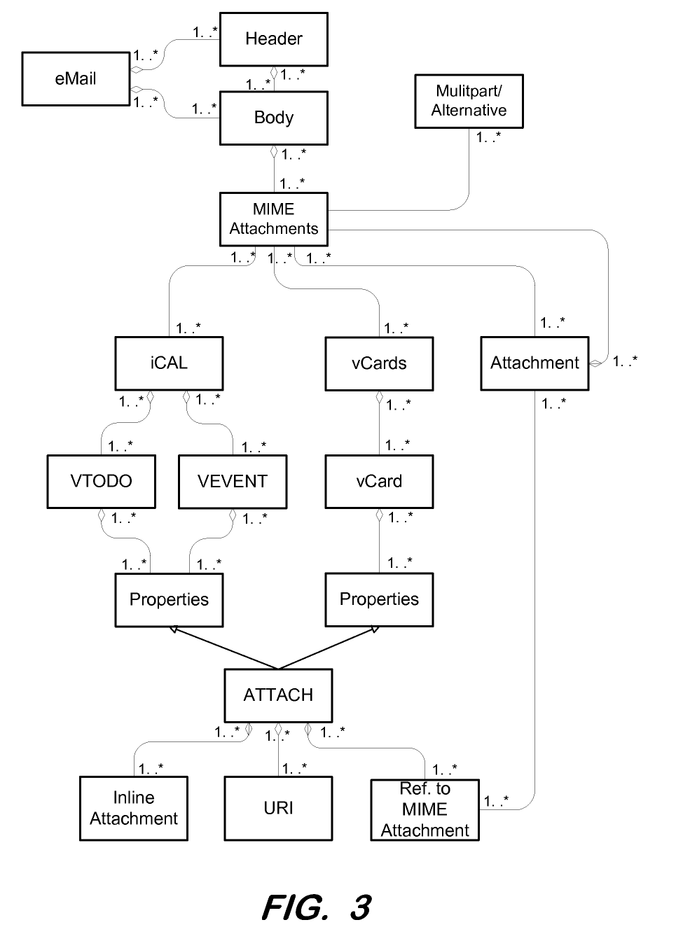

A header of the electronic mail message is parsed at S420. The header is an informational portion of the electronic mail message required by standard electronic mail protocols. FIG. 3 depicts an electronic mail structure according to standard protocols.

The header typically includes fields specifying MIME version, content type, content transfer encoding, a subject, a date, a message ID, servers from which the message was received (“received from” servers), sender email address, and recipient mail address. A header may include other required and optional fields in some embodiments. Parsing at S420 may comprise identifying the various individual fields of the header. According to some embodiments, S420 comprises identifying all “received from” fields of the header.

Next, it is determined at S430 whether any routing devices are identified in the header. The determination may comprise checking the “received from” fields of the header for indications of routing devices. As described above, mail servers or other routing devices may add identifying information to a header of a received electronic mail message prior to forwarding the message to another routing device.

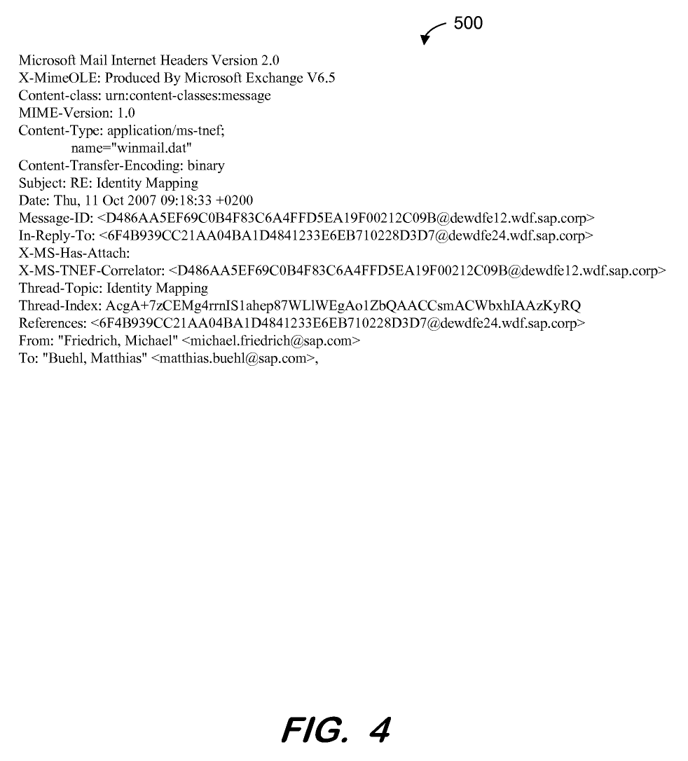

FIG. 4 illustrates header 500 that may be checked at S430 according to some embodiments. For the present example, it will be assumed that header 500 is associated with an electronic mail message transmitted from mail server 120 to mail server 110 along transmission path A of FIG. 1.

Header 500 does not include any routing devices. Header 500 is determined to identify an electronic mail message originating from within trusted network 100 (i.e., an “internal message). Accordingly, it is determined to accept the message at S440. Acceptance of the message may comprise passing the message to appropriate processes of application servers 150 for further processing. Flow then returns to S410 to receive a next internet electronic mail message.

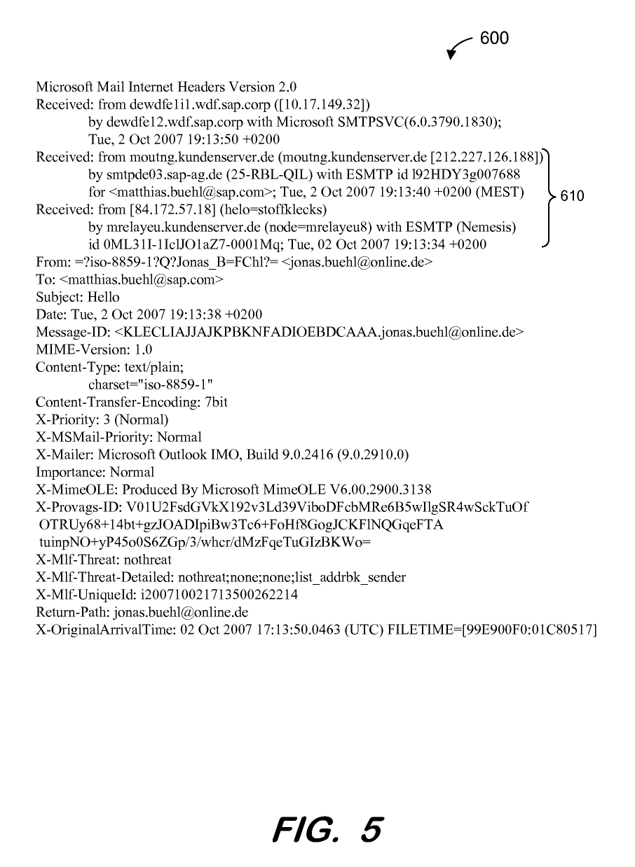

Flow proceeds from S430 to S450 if routing devices are located in the header. Header 600 of FIG. 5 is associated with an electronic mail message transmitted from server 200 to server 110 along transmission path B of FIG. 1. Header 600 includes several “received from” fields specifying the routing devices (i.e., mail servers) along transmission path B. Accordingly, flow proceeds to S450 in the case of header 600.

At S450, it is determined whether any of the specified routing devices are external mail servers. According to some embodiments of S450, IP address and/or other identifying information of the specified routing devices is checked against a database of known internal mail servers. Continuing with the example of header 600, fields 610 are identified as specifying external mail servers 200 and 300. The electronic mail message is therefore identified as “external” and rejected at S460. Rejection of the electronic mail message may comprise one or more of deletion of the message, redirection of the message to a junk or quarantine folder, or other process.

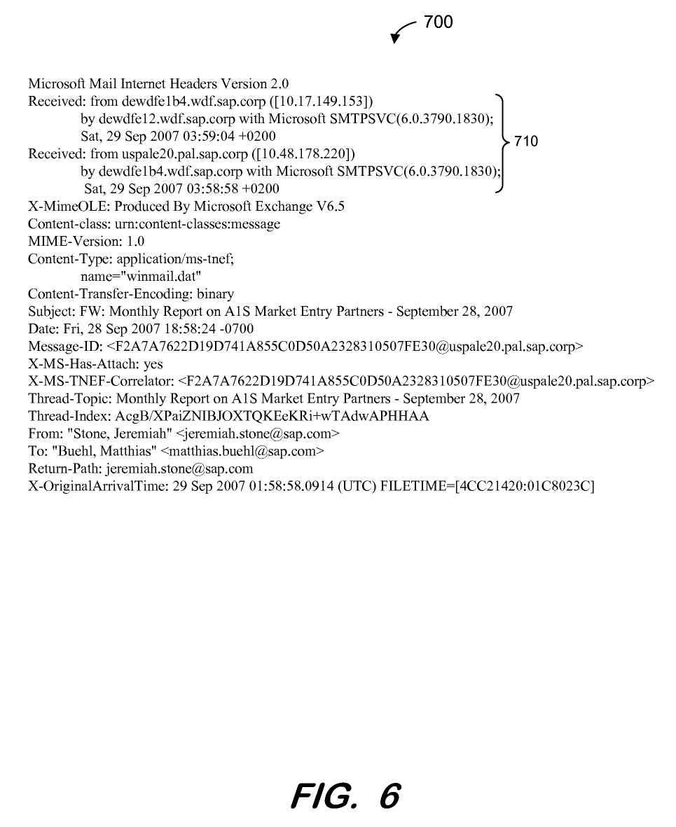

Flow proceeds from S450 to S470 if none of the routing devices specified in the header are external mail servers. Header 700 of FIG. 6 is associated with an electronic mail message transmitted from server 130 to server 110 along transmission path C of FIG. 1. Header 700 includes several “received from” fields specifying the routing devices (i.e., mail servers) along transmission path C, and none of the specified routing devices are external mail servers. Flow therefore proceeds from S430 to S450 and from S450 to S470 in the case of header 700.

It is determined at S470 whether each of the specified routing devices is an internal mail server. In the example of header 700, fields 710 are identified as specifying internal mail servers 130 and 120. The electronic mail message is therefore identified as “internal” and accepted at S440 as described above.

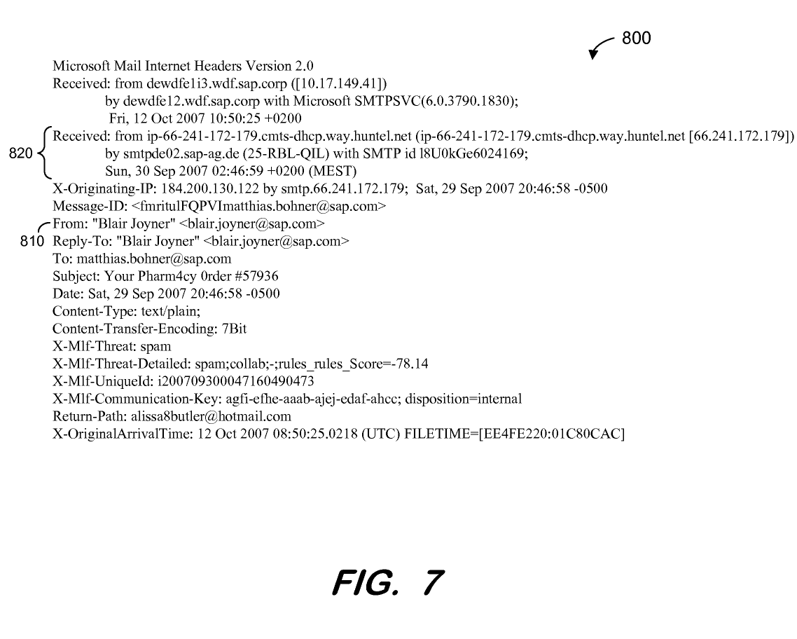

Header 800 of FIG. 7 is associated with an electronic message transmitted from mail server 300 to mail server 110 along transmission path D. Header 800 illustrates an attempt by server 300 to “spoof” an internal mail address of trusted network 100. Specifically, header 800 specifies internal sender address 810. However, “received from” mail server 820 is an external mail server. When subjected to process 400, mail server 820 would be identified as external at S450 and the electronic mail message would be rejected.

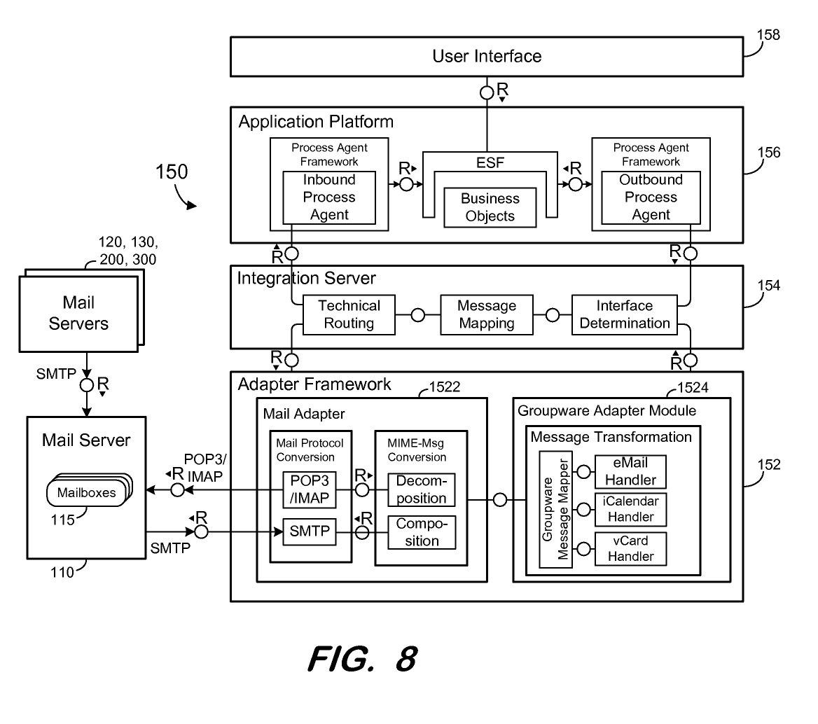

FIG. 8 is a detailed block diagram of a portion of system 10 according to some embodiments. Some embodiments of system 10 may differ from that illustrated in FIG. 8.

As described above, mail server 110 receives internet electronic mail messages having recipient electronic mail addresses which include the domains with which mail server 110 is associated. Each of mailboxes 115 of mail server 110 is associated with a local-part (e.g., a username) of a domain with which mail server 110 is associated. One of mailboxes 115 therefore stores electronic mail messages having recipient electronic mail addresses which specify the local-part and domain associated with that mailbox 115.

Application servers 150 include adapter framework 152, integration server 154, application platform 156 and user interface 158. Adapter framework 152 includes mail adapter 1522 and groupware adapter module 1524. Mail adapter 1522 and/or groupware adapter module 1524 may operate in some embodiments to provide the functionality described herein.

According to some embodiments, adapter framework 152 uses adapters to facilitate communication between a business process platform and separate systems associated with each of the adapters. Each adapter, in turn, may operate in conjunction with one or more adapter modules. Adapter framework 152 may therefore include more adapters and adapter modules than illustrated in FIG. 8. Adapter framework 152 may comprise the SAP XI Adapter Framework according to some embodiments.

Integration server 154 routes messages to and from appropriate interfaces of application platform 156. Integration server 154 may also provide mapping of incoming and outgoing messages according to pre-configured mappings. SAP XI provides an integration server suitable for use in conjunction with some embodiments.

Application platform 156 supports process agents for implementing message interfaces (i.e., providing Web services) by communicating with an Enterprise Service Framework (ESF), such as a Service-Oriented Architecture (SOA) provided by SAP AG. The ESF provides an API for instantiating and manipulating business objects which encapsulate data and related methods of business logic that describes a business process or task.

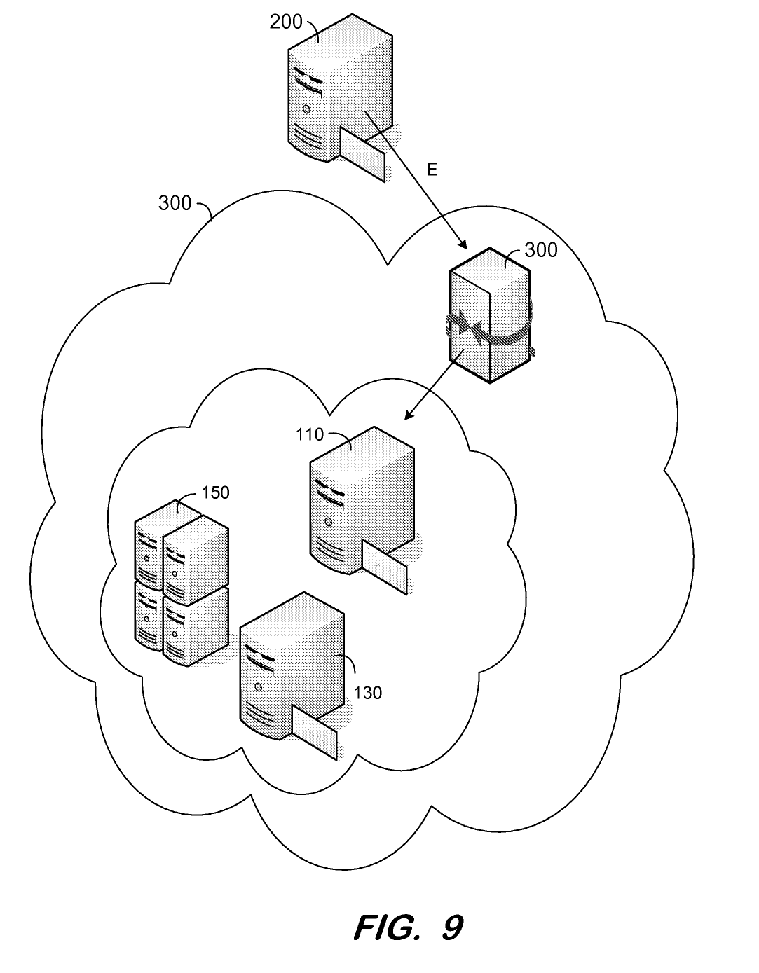

FIG. 9 illustrates a topology according to some embodiments in which trusted network 10 is disposed within demilitarized zone (DMZ) 20. DMZ 20 is intended to isolate private servers of trusted network 10. DMZ 20 includes external gateway 160 to receive any network traffic incoming to trusted network 10. DMZ 20 may include additional gateways, servers, firewalls, and other devices according to some embodiments.

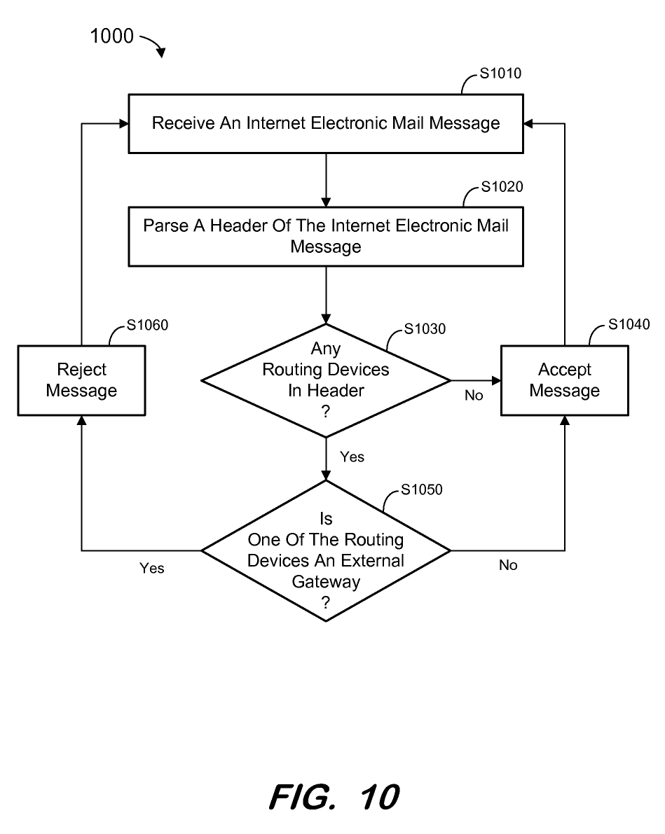

FIG. 10 is a flow diagram of process 1000 according to some embodiments. Process 1000 may be executed by application servers 150 to identify internal and external electronic mail messages within the FIG. 9 environment.

An internet electronic mail message is received at S1010. In the present example, it will be assumed that the electronic mail message is received from mail server 110 by a mail client (such as mail adapter 1522) of application servers 150. Moreover, it will be assumed that the mail message was sent by mail server 200 along transmission path E.

A header of the electronic mail message is parsed at S1020, and the “received from” fields of the header are checked at S1030 to determine whether any routing devices are identified in the header. If no devices are identified, the message is accepted at S1040.

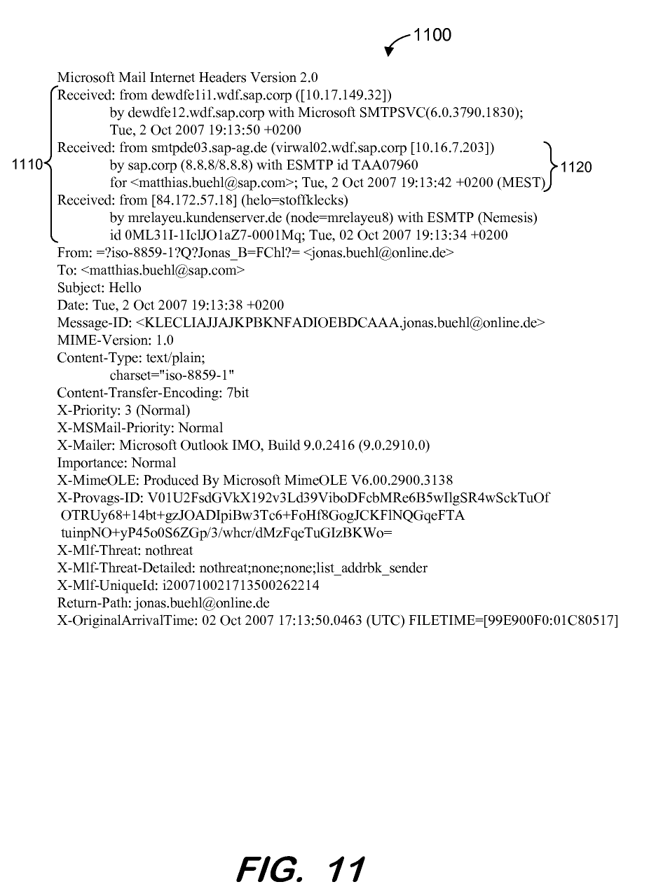

FIG. 11 illustrates header 1100 according to the present example. Flow proceeds to S1050 from S1030 because header 1100 specifies three routing devices 1110 (i.e. mail server 200, external gateway 160 and mail server 110).

At S1050, it is determined whether any of the specified routing devices is external gateway 160. Continuing with the example of header 1100, field 1120 is identified as specifying external gateway 160 based on known identifying information of gateway 160. The electronic mail message is therefore identified as “external” and rejected at S1060. The electronic mail message is identified as “internal” and accepted at S1040 if none of the specified routing devices is external gateway 160.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those in the art will recognize other embodiments may be practiced with modifications and alterations limited only by the claims.

What is claimed is:

1. A method comprising:
receiving an internet electronic mail message;
parsing a header of the internet electronic mail message to identify zero or more routing devices from which the internet electronic mail message was received; and
determining to accept or to reject the internet electronic mail message based on the identified zero or more routing devices.

2. A method according to claim 1, wherein determining to accept or to reject the internet electronic mail message comprises:
determining that the identified zero or more routing devices include one or more of external mail servers,
the method further comprising:
rejecting the internet electronic mail message.

3. A method according to claim 1, wherein determining to accept or to reject the internet electronic mail message comprises:
determining that each of the identified zero or more routing devices is an internal mail server,
the method further comprising:
accepting the internet electronic mail message.

4. A method according to claim 1, wherein determining to accept or to reject the internet electronic mail message comprises:
determining that zero routing devices were identified,
the method further comprising:
accepting the internet electronic mail message.

5. A method according to claim 1, wherein determining to accept or to reject the internet electronic mail message comprises:
determining that the identified zero or more routing devices include an external gateway,
the method further comprising:
rejecting the internet electronic mail message.

6. A computer-readable medium storing processor-executable process steps, the process steps comprising:
a step to receive an internet electronic mail message;
a step to parse a header of the internet electronic mail message to identify zero or more routing devices from which the internet electronic mail message was received; and
a step to determine to accept or to reject the internet electronic mail message based on the identified zero or more routing devices.

7. A medium according to claim 6, wherein the step to determine to accept or to reject the internet electronic mail message comprises:
a step to determine that the identified zero or more routing devices include one or more of external mail servers,
the process steps further comprising:
a step to reject the internet electronic mail message.

8. A medium according to claim 6, wherein the step to determine to accept or to reject the internet electronic mail message comprises:
a step to determine that each of the identified zero or more routing devices is an internal mail server,
the process steps further comprising:
a step to accept the internet electronic mail message.

9. A medium according to claim 6, wherein the step to determine to accept or to reject the internet electronic mail message comprises:
a step to determine that zero routing devices were identified,
the process steps further comprising:
a step to accept the internet electronic mail message.

10. A medium according to claim 6, wherein the step to determine to accept or to reject the internet electronic mail message comprises:
a step to determine that the identified zero or more routing devices include an external gateway,
the process steps further comprising:
a step to reject the internet electronic mail message.

11. A system comprising:
a mail server to receive an internet electronic mail message, to parse a header of the internet electronic mail message to identify zero or more routing devices from which the internet electronic mail message was received, and to determine to accept or to reject the internet electronic mail message based on the identified zero or more routing devices.

12. A system according to claim 11, wherein determination of whether to accept or to reject the internet electronic mail message comprises:
determination that the identified zero or more routing devices include one or more of external mail servers,
wherein the mail server is further to reject the internet electronic mail message.

13. A system according to claim 11, wherein determination of whether to accept or to reject the internet electronic mail message comprises:
determination that each of the identified zero or more routing devices is an internal mail server,
wherein the mail server is further to accept the internet electronic mail message.

14. A system according to claim 11, wherein determination of whether to accept or to reject the internet electronic mail message comprises:
determination that zero routing devices were identified,
wherein the mail server is further to accept the internet electronic mail message.

15. A system according to claim 11, wherein determination of whether to accept or to reject the internet electronic mail message comprises:
determination that the identified zero or more routing devices include an external gateway,
wherein the mail server is further to reject the internet electronic mail message.
